(19) United States
(12) Patent Application Publication
(10) Pub. No.: US 2011/0277588 A1
(43) Pub. Date: Nov. 17, 2011

(54) Vehicle Pedal Kickdown Assembly with Leaf Spring Element

(76) Inventor: Milan Klimes, Niles, MI (US)

(21) Appl. No.: 13/094,395

(22) Filed: Apr. 26, 2011

Related U.S. Application Data
(60) Provisional application No. 61/333,474, filed on May 11, 2010.

(51) Int. Cl. G05G 1/30

(52) U.S. Cl. 74/594.4

(57) ABSTRACT

A kickdown assembly for a pedal assembly including a pedal. In one embodiment, the kickdown assembly a leaf spring kickdown element including a base, a first arm which extends from a first end of the base and defines a recess, and a second arm which extends from a second end of the base and includes a distal end seated in the recess of the first arm and adapted to transfer a resistance force to the pedal when the second arm of the kickdown element contacts the pedal. The resistance force is overcome by the application of a kickdown or step force against the pedal which is greater than the resistance force and causes the distal end of the second arm of the kickdown element to spring out of the recess defined in the first arm of the kickdown element.

### CROSS-REFERENCE TO RELATED APPLICATIONS

This application claims the benefit of the filing date and disclosure of U.S. Provisional Patent Application Ser. No. 61/333,474 filed on May 11, 2010, the entire disclosure of which is explicitly incorporated herein by reference as are all references cited therein.

### FIELD OF THE INVENTION

The present invention relates generally to a vehicle pedal assembly and, more specifically, to a kickdown assembly for a vehicle accelerator pedal assembly.

### BACKGROUND OF THE INVENTION

A number of vehicles in use today incorporate accelerator pedal assemblies with kickdown stops or assemblies, i.e., assemblies which, when a pedal has been pressed down substantially to the full extent by the operator, generate and transfer a pedal resistance force which momentarily stops or prevents the further downward movement of the pedal by the operator and provides the operator with an indication that the automatic transmission will be shifting down to a lower gear following the operator's application of a pedal kickdown or step force greater than the resistance force.

The present invention is directed to an accelerator pedal assembly incorporating a new and more cost effective kickdown assembly.

### SUMMARY OF THE INVENTION

The present invention is generally directed to a kickdown assembly for a pedal assembly which comprises a kickdown element including a base with opposed first and second ends, a first arm which extends from the first end of the base and defining a nest, and a second arm which extends from the second end of the base and has a distal end segment seated in the nest defined in the first arm and adapted to slide out of the nest defined in the first arm in response to the application of a kickdown force against the second arm sufficient to move the second arm.

In one embodiment, the pedal assembly includes a pedal and a pedal base, the kickdown element is coupled to one of the pedal or the pedal base, the pedal is rotatable in the direction of the pedal base into a relationship in which the other of the pedal or the pedal base is positioned in abutting relationship with the second arm of the kickdown element for applying a resistance force to the pedal and moving the second arm of the kickdown element in response to the application of the kickdown force against the pedal sufficient to overcome the resistance force.

In one embodiment, the pedal includes a lower surface and the base of the kickdown element is coupled to the lower surface of the pedal and the second arm of the kickdown element is positioned in a relationship opposed to the pedal base, and the second arm of the kickdown element is adapted to abut the pedal base in response to the rotation of the pedal in the direction of the pedal base.

In one embodiment, the pedal base includes a kickdown activation button adapted for abutting relationship with the second arm of the kickdown element in response to the rotation of the pedal in the direction of the pedal base.

In another embodiment, the pedal assembly includes a pedal coupled for rotation to a pedal housing defining an interior cavity, the kickdown element is mounted in the interior cavity of the pedal housing, the pedal includes a pedal lever arm which extends into the interior cavity of the pedal housing and terminates in a distal end segment adapted to abut against the second arm of the kickdown element in response to the rotation of the pedal relative to the pedal housing, and the second arm of the kickdown element is adapted to apply a resistance force against the pedal lever arm and the pedal and the pedal lever arm is adapted to move the second arm of the kickdown arm in response to the application of the kickdown force against the pedal greater than the resistance force.

In one specific embodiment, the present invention is directed to a kickdown assembly for a pedal assembly including a pedal coupled for rotation to a pedal housing wherein the kickdown assembly comprises a kickdown activation button associated with the pedal or the pedal housing; and a kickdown element associated with one of the pedal or the pedal housing and including first and second arms, the first arm defining a recess adapted to receive a terminal end of the second arm, the second arm abutting against the other of the pedal or the pedal housing in response to the rotation of the pedal relative to the pedal housing and adapted to apply a resistance force to the pedal.

In this one specific embodiment, the kickdown element projects outwardly from a bottom face of the pedal and a kickdown activation surface is defined on the pedal housing and adapted for abutting relationship with the second arm of the kickdown element in response to rotation of the pedal in the direction of the pedal housing.

In this embodiment, the first arm of the kickdown element also defines a bump and the terminal end of the second arm of the kickdown element is adapted to ride over the bump in response to the application of a kickdown force against the second arm greater than the resistance force.

In one embodiment, the kickdown element is in the form of a leaf spring which has been bent and shaped to define said first and second arms and a base therebetween.

In another specific embodiment, the present invention is directed to a kickdown assembly for a pedal assembly including a pedal adapted for rotation relative to a pedal housing defining an interior cavity wherein the kickdown assembly comprises a kickdown activation lever in the interior cavity of the pedal housing and projecting outwardly from an end of the pedal; and a kickdown element located in the interior cavity of the pedal housing and including first and second arms, the first arm defining a recess adapted to receive the terminal end of the second arm, the second arm abutting against the kickdown activation lever in response to the rotation of the pedal relative to the pedal housing and adapted to apply a resistance force to the pedal.

There are other advantages and features that will be more readily apparent from the following description of the invention, the drawings, and the appended claims.

### BRIEF DESCRIPTION OF THE DRAWINGS

In the accompanying drawings that form a part of the specification:

FIG. 1 is a vertical cross-sectional view of a first embodiment of an accelerator pedal assembly incorporating a kickdown assembly in accordance with the present invention;

FIG. 2 is an enlarged, broken, perspective view of the kickdown activation button of the kickdown assembly of the pedal assembly shown in FIG. 1;

FIG. 3 is a partially broken, perspective view of a second embodiment of an accelerator pedal assembly incorporating the kickdown assembly in accordance with the present invention;

FIG. 4 is an enlarged, perspective view of the leaf spring element of the kickdown assembly of the present invention; and

FIGS. 5-10 are side views depicting the position of, and relationship between, the respective arms of the leaf spring element of the kickdown assembly at various pedal force positions.

### DETAILED DESCRIPTION OF THE EMBODIMENTS

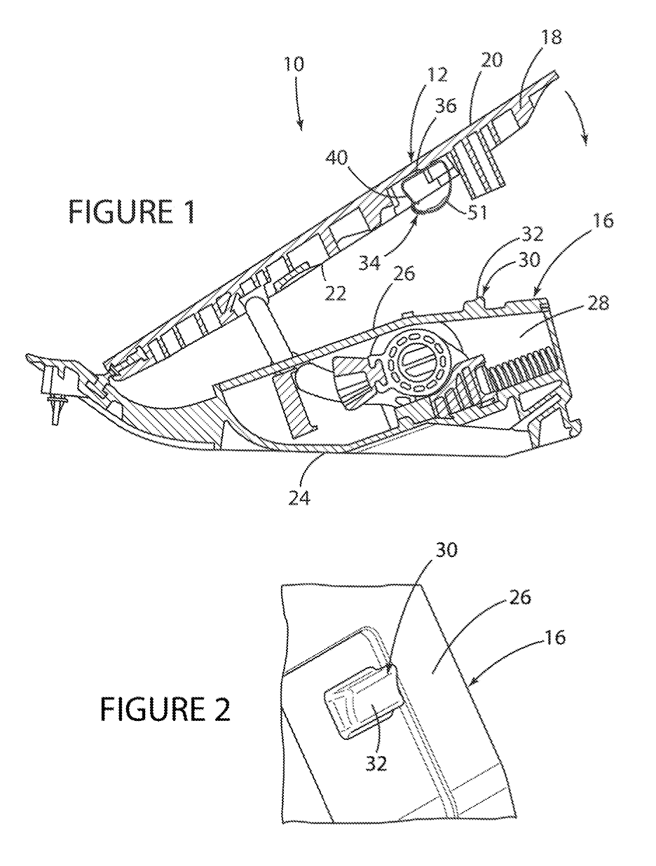

A first embodiment of a pedal assembly 10, incorporating a kickdown assembly in accordance with the present invention, is shown in FIG. 1 and comprises an elongated pedal 12 coupled to, and mounted for rotation relative to, a pedal housing or base 16, both of which may be made from a suitable plastic material. In the embodiment shown, the pedal 12 is located opposite and spaced from the pedal base 16.

Also, in the embodiment shown, the pedal 12 includes an elongate flat body or plate 18 having a top or upper surface 20 and a bottom or lower surface 22. The pedal housing or base 16 includes, among other elements, a generally flat bottom or lower plate or wall 24 and a top or upper wall 26 which together with side walls (not shown) define an interior cavity 28 which houses certain of the elements of the pedal assembly 10. In the embodiment of FIG. 1, the bottom or lower surface 22 of the pedal 12 is located above, opposite, and spaced from, the top or upper wall 26 of the pedal base 16.

A kickdown assembly activation button 30 projects outwardly from the outer surface of the top wall 26 of the pedal base 16 and extends in the direction of the pedal 12. As shown in FIG. 2, the activation button 30 includes a top or distal arcuate or curved end face 32.

The kickdown assembly comprises a profiled kickdown activation leaf spring element 34 which, as shown in FIG. 1, is coupled to and projects outwardly from the bottom surface 22 of the plate 18 of the pedal 12 in a relationship above, opposed to, and spaced from, the top wall 26 of the pedal housing or base 16 and, more specifically, in a relationship above, opposed, and spaced, from the button 30 projecting outwardly from the top wall 26 of the pedal housing or base 16.

As shown in greater detail in FIG. 4, the profiled kickdown leaf spring element 34 comprises an elongate strip of metal or the like flexible and resilient material which, in the embodiment shown, has been bent into a generally “D” shape and configuration and includes overlapping distal end segments 48 and 54 as described in more detail below.

As shown in FIG. 4, the kickdown leaf spring element 34 initially comprises a generally flat back mounting wall or strip or base of metal 36 defining a through-hole 38 adapted to receive a screw or the like (not shown) for mounting and securing the leaf spring element 34 and, more specifically, the back base strip of metal 36 thereof to the lower surface 22 of the plate 18 of the pedal 12.

The leaf spring element 34 additionally comprises a first elongate flexible and resilient spring arm or strip of metal 40 extending unitarily outwardly from, and in a relationship generally normal to, a first end 43 of the back base strip of metal 36. The first arm or strip of metal 40 is shaped and bent to include and terminate in a free distal end segment or portion 48 which projects, extends, and curls in the direction of the through-hole 38 defined in the base 36 of the leaf spring element 34 and additionally defines a generally concavely shaped recess or nest 42 and a generally convexly shaped bump or raised portion 46 defined adjacent the recess or nest 42 and, more specifically, defined on the first arm 40 between the first end 43 of the base 36 and the recess or nest 42.

The leaf spring element 34 still further comprises a second elongate flexible and resilient kickdown activation spring arm 51 extending and projecting unitarily outwardly from a second end 45 of the back base wall or strip of metal 36 of the leaf spring element 34 located opposite and spaced from the first end 43 thereof. The spring arm 51 includes an elongate arcuate segment 52 which curves from the second end 45 of the base strip 36 in the direction of the first arm or strip of metal 40 and in a relationship opposed and spaced from the first arm 40 and terminates in a distal inwardly curled end segment or portion 54 which, as shown in FIG. 4, is received and seated in the recess or nest 42 and abutted against the bump 46 defined in the distal end segment 48 of the first wall or strip of metal 40 of the leaf spring element 34. In the position and relationship of FIG. 4, the exterior surface of the distal end segment 54 of the second arm 51 is abutted against the interior surface of the distal end segment 48 of the first arm 40. The arm 51 additionally includes an outer surface defining a recess or dimple 55.

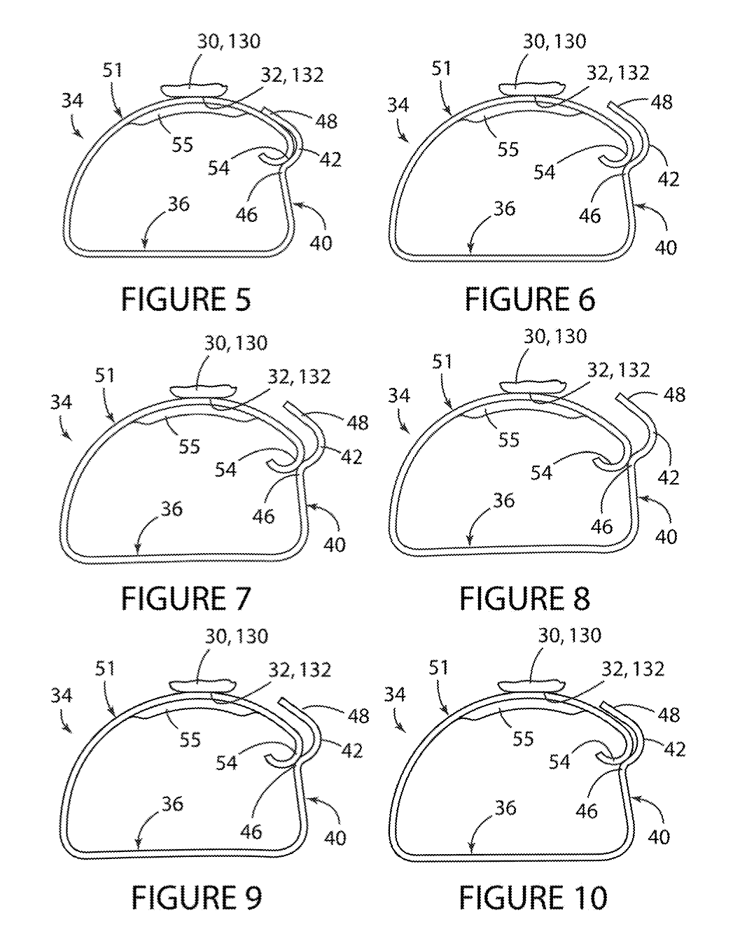

Referring back to FIG. 1, the pedal 12 and, more specifically, the pedal plate 18, is adapted to be rotated in a clockwise direction toward the pedal base 16 in response to the depression of the pedal plate 18 by the foot (not shown) of the operator (not shown) of a vehicle (not shown) into a relationship in which the spring arm 51 of the leaf spring element 34 and, more specifically, the dimple 55 defined in the outer surface thereof, comes into frictional abutting contact with the distal end face 32 of the button 30 projecting outwardly from the housing base 16 which, initially and as a result of the receipt and nesting of the distal end segment 54 of the spring arm 51 in the recess 42 and against the bump 46 defined in the distal end segment 48 of the spring arm 40 as shown in FIGS. 4 and 5, causes the spring arm 51 to generate and transfer a resistance force successively to the pedal plate 18, the pedal 12, and then the foot of the operator.

The resistance force created by the leaf spring element 34 and subsequently applied to the pedal plate 18 and the pedal 12, in turn, prevents the further downward movement of the pedal plate 18 by the foot of the operator and provides an indication to the operator that the vehicle will be shifting down into a lower gear following the operator's application of a kickdown or step force on the pedal 12 and plate 18 greater than, and sufficient to overcome, the resistance force.

More specifically, and as shown in FIGS. 6-8, the application to the pedal 12 of a kickdown or step force on the pedal greater in magnitude than the leaf spring element resistance force causes the distal curled end segment 54 of the spring arm 51 to slide or spring out of the recess 42 defined in the spring arm 40 and travel or ride or slide over the outer surface of the bump 46 defined by the spring arm 40, the rearward or inward movement and deflection of the leaf spring arm 51 in the direction of the back base wall 36 of the leaf spring element 34, and the outward movement or deflection of the first arm 40 away from the second arm 51. Once the end 54 of the second arm 51 exits the recess 42 and rides over the bump 46, the force drops significantly.

In accordance with the invention, the level or magnitude of the resistance force created by the leaf spring element 34 and the level or magnitude of the kickdown or step force necessary to overcome the resistance force will be dependent upon and may be adjusted or changed by adjusting or changing a variety of parameters including, but not limited to, the following: the material and/or resistive spring force characteristics of the leaf spring element 34 and, more specifically, the material or thickness of the arms 40 and 51 thereof; the profile or configuration or size of the leaf spring element 34 and, more specifically, the profile or configuration or size of the arms 40 and 51 thereof and, still more specifically, the profile or configuration of the end segments 48 and 54 of the respective arms 40 and 51 of the leaf spring element 34 and, still more specifically, the depth of the recess 42 and the height of the bump 46 defined in the distal end segment 48 of the arm 40; and/or the material or profile or configuration or size of the kickdown activation button 30 including, but not limited to, the material or profile or configuration of the distal end face 32 thereof.

Although not described herein in any detail, it is also understood that, when the operator removes his/her foot from the pedal 12, the pedal 12 will rotate back counter-clockwise relative to the pedal housing 16 which, in turn, will cause the spring arm 51 of the leaf spring element 34 to spring rearwardly or away from the base wall 36 thereof back as shown in FIGS. 9 and 10 into the resistive force position of FIGS. 4 and 5 where the distal end 54 of the spring arm 51 is seated and nested in the recess 42 and abutted against the bump 46 defined on the arm 40 of the leaf spring element 34.

Numerous variations and modifications of the pedal assembly and kickdown assembly and element embodiments described above may be effected without departing from the spirit and scope of the novel features of the invention and it is understood that no limitations with respect to the specific pedal assembly or kickdown assembly and element illustrated herein are intended or should be inferred. It is, of course, intended to cover by the appended claims all such modifications as fall within the scope of the claims including, for example, the pedal assembly embodiment wherein the kickdown activation button 30 is located on the pedal 12 and the kickdown leaf spring element 34 is located on the pedal base 16.

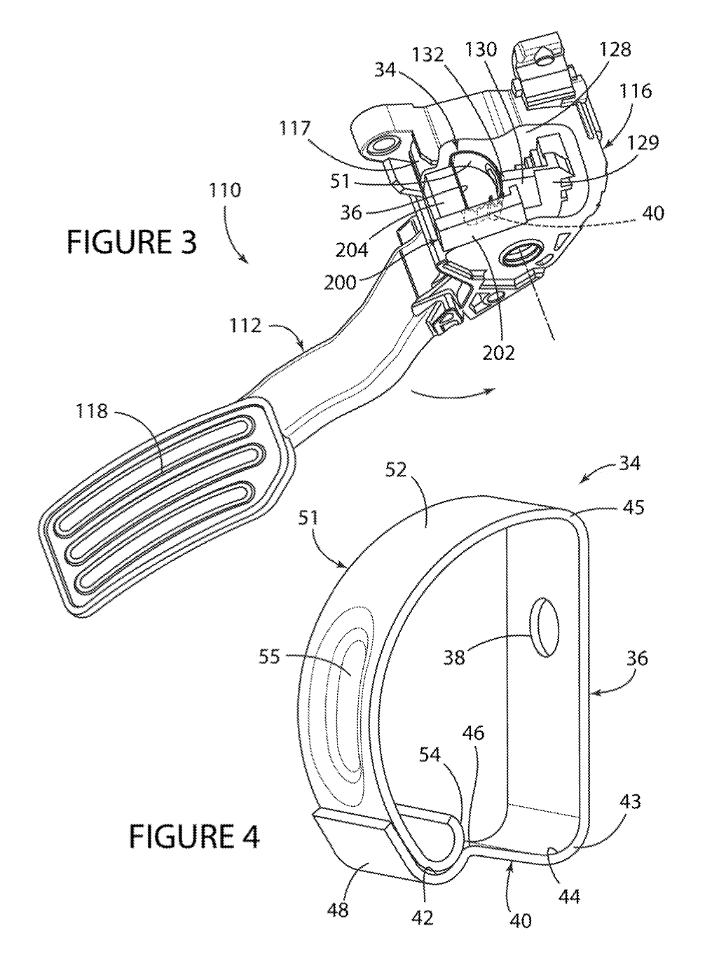

Another example embodiment of a pedal assembly 110 adapted to incorporate the leaf spring kickdown element 34 of the present invention is shown in FIG. 3 which comprises an elongated pedal 112 including a pedal plate 118 at one end and a drum (not shown) at an opposite end which extends into the interior cavity 128 of a pedal housing or base 116. A curved pedal lever arm 129, also located in the interior cavity 128 of the pedal housing 116, extends unitarily outwardly from the drum (not shown) and terminates in a distal kickdown assembly activation end segment or button 130 including a distal arcuate or curved exterior end face 132 similar in configuration to the end face 32 of the kickdown activation button 30 shown in FIG. 2.

In this pedal assembly embodiment 110, the kickdown leaf spring element 34 is located in the interior cavity 128 of the pedal housing 116 and, still more specifically, is mounted to a generally L-shaped bracket 200 located in the interior cavity 128 of the pedal housing 116. The bracket 200 includes a pair of bracket arms 202 and 204 disposed relative to each other in a generally normal relationship and the leaf spring element 34 is mounted to the bracket 200 and located in the interior cavity 128 of the pedal housing 116 between the pedal lever arm 129 and a front wall 117 of the pedal housing 116 in a relationship wherein the back base wall 36 of the leaf spring element 34 is coupled to an outside face of the bracket arm 204, the first spring arm 40 of the leaf spring element 34 is located adjacent and generally parallel to the bracket arm 202, and the second spring arm 51 is located opposite and adjacent the end face 132 of the button 130 of the pedal lever arm 129.

The pedal 112 is adapted to be rotated in the counter-clockwise direction shown in FIG. 3 in response to the depression of the pedal plate 118 by the foot (not shown) of the operator (not shown) of a vehicle (not shown). This movement, in turn, causes the counter-clockwise movement of the pedal lever arm 129 in the interior cavity 128 of the pedal housing 116 in the direction of the front wall 117 of the pedal housing 116 which causes the exterior face 132 of the distal button 130 at the end of the pedal lever arm 129 into abutting contact with the outside or exterior face of the spring arm 52 of the kickdown leaf spring element 34 which, initially and as a result of the receipt and nesting of the end segment 54 of the spring arm 51 in the recess 42 and against the bump 46 defined in the end segment 48 of the spring arm 40 of the pedal 112, causes the generation and transfer of a resistance force by the spring arm 51 successively to and through the drum (not shown) of the pedal 112, the pedal 112, the pedal plate 118, and then to the foot (not shown) of the operator (not shown).

As with the first pedal assembly embodiment 10 of FIG. 1, the resistance force applied against the pedal plate 118 of the pedal assembly 110, in turn, prevents the further counter-dockwise movement of the pedal 112 by the operator and, as described above, provides an indication to the operator that the vehicle will be shifting down into a lower gear following the operator's application of a kickdown or step force against the pedal 112 sufficient to overcome the resistance force in the same manner as described above with respect to the pedal assembly 10 and thus the description above of the operation of the kickdown element 34 following the application of the appropriate kickdown or step force against the pedal 112 is incorporated herein by reference.

What is claimed is:

1. A pedal kickdown assembly for a pedal assembly, the pedal kickdown assembly comprising a kickdown element including a base with opposed first and second ends, a first arm extending from the first end of the base and defining a nest, a second arm extending from the second end of the base and having a distal end segment seated in the nest defined in the first arm and adapted to slide out of the nest defined in the first arm in response to the application of a kickdown force against the second arm sufficient to move the second arm.

2. The pedal kickdown assembly of claim 1, wherein the pedal assembly includes a pedal and a pedal base, the kickdown element being coupled to one of the pedal or the pedal base, the pedal being rotatable in the direction of the pedal base into a relationship in which the other of the pedal or the pedal base is positioned in abutting relationship with the second arm of the kickdown element for applying a resistance force to the pedal and adapted to move the second arm of the kickdown element in response to the application of the kickdown force against the pedal sufficient to overcome the resistance force.

3. The pedal kickdown assembly of claim 2, wherein the pedal includes a lower surface and the base of the kickdown element is coupled to the lower surface of the pedal and the second arm of the kickdown element is positioned in a relationship opposed to the pedal base, the second arm of the kickdown element being adapted to abut the pedal base in response to the rotation of the pedal in the direction of the pedal base.

4. The pedal kickdown assembly of claim 3, wherein the pedal base includes a kickdown activation button adapted for abutting relationship with the second arm of the kickdown element in response to the rotation of the pedal in the direction of the pedal base.

5. The pedal kickdown assembly of claim 1, wherein the pedal assembly includes a pedal coupled for rotation to a pedal housing defining an interior cavity, the kickdown element being mounted in the interior cavity of the pedal housing, the pedal including a pedal lever arm extending into the interior cavity of the pedal housing and terminating in a distal end segment adapted to abut against the second arm of the kickdown element in response to the rotation of the pedal relative to the pedal housing, the second arm of the kickdown element being adapted to apply a resistance force against the pedal lever arm and the pedal and the pedal lever arm being adapted to move the second arm of the kickdown am, in response to the application of the kickdown force against the pedal greater than the resistance force.

6. The pedal kickdown assembly of claim 1, wherein the second arm of the kickdown element is arcuate and terminates in a curled second distal end segment.

7. A kickdown assembly for a pedal assembly including a pedal coupled for rotation to a pedal housing, the kickdown assembly comprising:
a kickdown activation button associated with the pedal or the pedal housing;
a kickdown element associated with one of,the pedal or the pedal housing and including first and second arms, the first arm defining a recess adapted to receive a terminal end of the second arm, the second arm abutting against the other of the pedal or the pedal housing in response to the rotation of the pedal relative to the pedal housing and adapted to apply a resistance force to the pedal.

8. The kickdown assembly of claim 7, wherein the kickdown element projects outwardly from a bottom face of the pedal and a kickdown activation surface is defined on the pedal housing and adapted for abutting relationship with the second arm of the kickdown element in response to rotation of the pedal in the direction of the pedal housing.

9. The kickdown assembly of claim 7, wherein the first arm of the kickdown element also defines a bump, the terminal end of the second arm of the kickdown element being adapted to ride over the bump in response to the application of a kickdown force against the second arm greater than the resistance force.

10. The kickdown assembly of claim 7, wherein the kickdown element is in the form of a leaf spring which has been bent and shaped to define said first and second arms and a base therebetween.

11. A kickdown assembly for a pedal assembly including a pedal adapted for rotation relative to a pedal housing defining an interior cavity, the kickdown assembly comprising:
a kickdown activation lever in the interior cavity of the pedal housing and projecting outwardly from an end of the pedal; and
a kickdown element located in the interior cavity of the pedal housing and including first and second arms, the first arm defining a recess adapted to receive the terminal end of the second arm, the second arm abutting against the kickdown activation lever in response to the rotation of the pedal relative to the pedal housing and adapted to apply a resistance force to the pedal.

12. The kickdown assembly of claim 11, wherein the first arm of the kickdown element also defines a bump, the terminal end of the second arm of the kickdown element being adapted to ride over the bump in response to the application of a kickdown force against the second arm greater than the resistance force.

13. The kickdown assembly of claim 11, wherein the kickdown element is in the form of a leaf spring which has been bent and shaped to define said first and second arms and a base therebetween.
